(19) United States
(12) Patent Application Publication
(10) Pub. No.: US 2018/0031177 A1
(43) Pub. Date: Feb. 1, 2018

(54) Display Lifting Device Firm In Connection

(71) Applicant: Xiaogan City Kapulong Daily Necessities Co., Ltd., Xiaogan (CN)

(72) Inventor: Xudong Sun, Xiaogan (CN)

(73) Assignee: Xiaogan City Kapulong Daily Necessities Co., Ltd., Xiaogan (CN)

(21) Appl. No.: 15/659,260

(22) Filed: Jul. 25, 2017

(30) Foreign Application Priority Data
Jul. 29, 2016 (CN) 201610610681.2

(51) Int. Cl. F16M 13/02

(52) U.S. Cl. CPC F16M 13/02; H04N 5/655

(57) ABSTRACT

Provided is a display lifting device firm in connection. The lifting device is used for bearing a display in a suspension mode and comprises a left arm plate and a right arm plate fastened on a roof separately, an upper supporting rod and a lower supporting rod penetrating the left arm plate and the right arm plate in the left-right direction respectively and a display carrier, wherein the upper supporting rod comprises an upper supporting rod main body and a thread pushing driving part in axial fixed connection with the left end of the upper supporting rod main body through an upper thrust bearing, and the lower supporting rod comprises a lower supporting rod main body and a thread pushing driving part in axial fixed connection with the left end of the lower supporting rod main body through a lower thrust bearing.

### CROSS-REFERENCES TO RELATED APPLICATIONS

The present application claims priority from Chinese application No. 201610610681.2 filed Jul. 29, 2016 which is hereby incorporated herein by reference in its entirety.

### FIELD OF THE INVENTION

The invention relates to the field of displays and particularly discloses a display lifting device firm in connection and used for displays.

### BACKGROUND OF THE INVENTION

Displays usually need lifting in use under some occasions, such as public halls, waiting halls or some office environments. Due to its high height, the fastener operating process which is complex and cumbersome is inconvenient to perform in the installation process. Especially under the circumstance where multiple groups of fasteners are set to ensure the installation firmness. Some simple fixing modes can hardly ensure the firmness, or though they can ensure the firmness, it is difficult to achieve a locking fastening effect, and the installed display device may have slight shaking, which brings inconvenience to use and leads to potential safety hazard.

### BRIEF DESCRIPTION OF THE FIGURES

FIG. 1 displays the overall structure diagram of the display lifting device firm in connection.

### BRIEF SUMMARY OF THE EMBODIMENTS OF THE INVENTION

The invention aims at providing a display lifting device firm in connection and used for displays to overcome the above shortcomings in the prior art.

The display lifting device firm in connection is used for bearing a display in a suspension mode and comprises the left arm plate and the right arm plate fastened on the roof separately, the upper supporting rod and the lower supporting rod penetrating the left arm plate and the right arm plate in the left-right direction respectively and the display carrier fixedly connected with the display, wherein the upper supporting rod comprises the upper supporting rod main body and the thread pushing driving part in axial fixed connection with the left end of the upper supporting rod main body through the upper thrust bearing, and the lower supporting rod comprises the lower supporting rod main body and the thread pushing driving part in axial fixed connection with the left end of the lower supporting rod main body through the lower thrust bearing. External threads are arranged on the external circumferences of the thread pushing driving part and the thread pushing driving part in fit with two threaded holes formed in the left arm plate at the front and the back. The tail ends of the thread pushing driving part and the thread pushing driving part are both provided with a tool junction part for driving rotating. The top of the display carrier is fixedly connected with the left fixed plate and the right fixed plate which are arranged separately in inside sliding grooves of the left arm plate and the right arm plate in a sliding mode. The positioning protrusion is respectively arranged at the tops of the inside sliding grooves in the left arm plate and the right arm plate to lock and position the left fixed plate and the right fixed plate when they stretch. Meanwhile, the positioning protrusions achieve face joint at the position of the end face after installation to improve structure stability. The ends of the left fixed plate and the right fixed plate sliding into the left arm plate and the right arm plate are respectively provided with the contact sensor. The alarm is arranged at the top of the display carrier between the left fixed plate and the right fixed plate. The alarm is electrically connected with the contact sensors, so that when the left fixed plate and the right fixed plate slide into the inside sliding grooves in the left arm plate and the right arm plate to enable the contact sensors to be in contact with the positioning protrusions, the contact sensors transfer signals and control the alarm to generate a sound alarm, and the sound alarm generated by the alarm can visually prompt that the left fixed plate and the right fixed plate slide into the inside sliding grooves in the left arm plate and the right arm plate in place. The upper taper hole and the lower taper hole which are separated are formed in the left fixed plate, and the upper taper hole and the lower taper hole which are separated are also formed in the right fixed plate correspondingly. Thus, the lower supporting rod can penetrate the lower taper hole in the right fixed plate and the lower taper hole in the left fixed plate from the right arm plate and stretch out from the left arm plate, and the upper supporting rod can penetrate the upper taper hole in the left fixed plate and the upper taper hole in the right fixed plate from the left arm plate and stretch out from the right arm plate. The upper supporting rod main body comprises the upper supporting rod left conical section matched with the upper taper hole in the left fixed plate, the middle upper supporting rod cylindrical section and the upper supporting rod right conical section matched with the upper taper hole in the right fixed plate. The lower supporting rod main body comprises the lower supporting rod left conical section matched with the lower taper hole in the left fixed plate, the middle lower supporting rod cylindrical section and the lower supporting rod right conical section matched with the lower taper hole in the right fixed plate.

By means of the above device, users do not need to use too many bolt fasteners to fasten the display, thereby simplifying the operation process at the high position. Further, the two supporting rods and the two arm plates are in cross linking, thereby improving the integral structure stability. Further, the conical matching surface is matched with the taper holes in the fixed plates of the display carrier, taper wedge-caulking can be achieved, and the display is prevented from being loosened in the operation process accordingly. Due to the fact that the convergent direction of the conical slope is different, the two holes with opposite wedge-caulking directions in the same main body of each fixed plate are pulled and jacked respectively, so that no combination force applied onto the corresponding fixed plate can be formed to the wedge-caulking push-pull force. At the same time, the push and pull forces can be offset, thus the connection structure of the fixed plates and the carrier main body is more stable and reliable.

### DETAILED DESCRIPTION OF THE EMBODIMENTS OF THE INVENTION

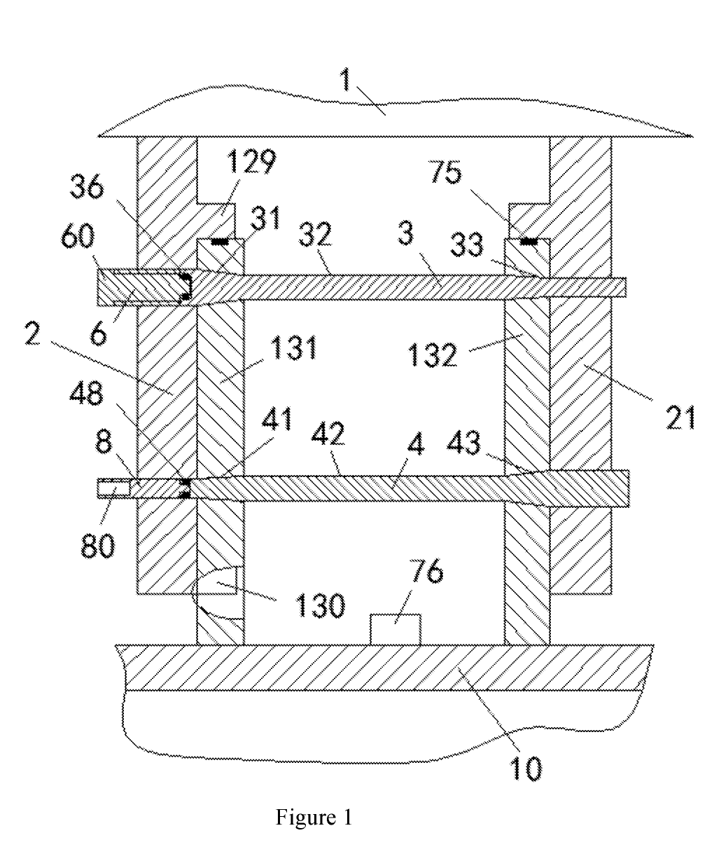

The invention is set out in detail according to FIG. 1 as follows.

The display lifting device firm in connection is used for bearing a display in a suspension mode and comprises the left arm plate 2 and the right arm plate 21 fastened on the roof 1 separately, the upper supporting rod 3 and the lower supporting rod 4 penetrating the left arm plate 2 and the right arm plate 21 in the left-right direction respectively and the display carrier 10 fixedly connected with the display, wherein the upper supporting rod 3 comprises the upper supporting rod main body and the thread pushing driving part 6 in axial fixed connection with the left end of the upper supporting rod main body through the upper thrust bearing 36, and the lower supporting rod 4 comprises the lower supporting rod main body and the thread pushing driving part 8 in axial fixed connection with the left end of the lower supporting rod main body through the lower thrust bearing 48. External threads are arranged on the external circumferences of the thread pushing driving part 6 and the thread pushing driving part 8 in fit with two threaded holes formed in the left arm plate 2 at the front and the back. The tail ends of the thread pushing driving part 6 and the thread pushing driving part 8 are both provided with a tool junction part 60 and 80 for driving rotating. The top of the display carrier 10 is fixedly connected with the left fixed plate 131 and the right fixed plate 132 which are arranged separately in inside sliding grooves 130 of the left arm plate 2 and the right arm plate 21 in a sliding mode. The positioning protrusion 129 is respectively arranged at the tops of the inside sliding grooves 130 in the left arm plate 2 and the right arm plate 21 to lock and position the left fixed plate 131 and the right fixed plate 132 when they stretch. Meanwhile, the positioning protrusions achieve face joint at the position of the end face after installation to improve structure stability. The ends of the left fixed plate 131 and the right fixed plate 132 sliding into the inside sliding grooves 130 of the left arm plate 2 and the right arm plate 21 are respectively provided with the contact sensor 75. The alarm 76 is arranged at the top of the display carrier 10 between the left fixed plate 131 and the right fixed plate 132. The alarm 76 is electrically connected with the contact sensors 75, so that when the left fixed plate 131 and the right fixed plate 132 slide into the inside sliding grooves 130 in the left arm plate 2 and the right arm plate 21 to enable the contact sensors 75 to be in contact with the positioning protrusions 129, the contact sensors 75 transfer signals and control the alarm 76 to give a sound alarm, and the sound alarm given by the alarm 76 can visually prompt that the left fixed plate 131 and the right fixed plate 132 slide into the inside sliding grooves 130 in the left arm plate 2 and the right arm plate 21 in place. The upper taper hole and the lower taper hole which are separated are formed in the left fixed plate 131, and the upper taper hole and the lower taper hole which are separated are also formed in the right fixed plate 132 correspondingly. Thus, the lower supporting rod 4 can penetrate the lower taper hole in the right fixed plate 132 and the lower taper hole in the left fixed plate 131 from the right arm plate 21 and stretch out from the left arm plate 2, and the upper supporting rod 3 can penetrate the upper taper hole in the left fixed plate 131 and the upper taper hole in the right fixed plate 132 from the left arm plate 2 and stretch out from the right arm plate 21. The upper supporting rod main body comprises the upper supporting rod left conical section 31 matched with the upper taper hole in the left fixed plate 131, the middle upper supporting rod cylindrical section 32 and the upper supporting rod right conical section 33 matched with the upper taper hole in the right fixed plate 132. The lower supporting rod main body comprises the lower supporting rod left conical section 41 matched with the lower taper hole in the left fixed plate 131, the middle lower supporting rod cylindrical section 42 and the lower supporting rod right conical section 43 matched with the lower taper hole in the right fixed plate 132.

Favorably or schematically, the tool junction part 60 is arranged on the peripheral surface or in the inner countersink at the tail end of the thread pushing driving part 6, and the tool junction part 80 is arranged on the peripheral surface or in the inner countersink at the tail end of the thread pushing driving part 8.

Favorably or schematically, the section of the lower supporting rod main body and/or the upper supporting rod main body is square.

By means of the device in the above embodiment, the users do not need to use too many bolt fasteners to fasten the display, thereby simplifying the operation process at the high position. Further, the two supporting rods and the two arm plates are in cross linking, thereby improving the integral structure stability. Further, the conical matching surface is matched with the taper holes in the fixed plates of the display carrier, taper wedge-caulking can be achieved, and the display is prevented from being loosened in the operation process accordingly. Due to the fact that the convergent direction of the conical slope is different, the two holes with opposite wedge-caulking directions in the same main body of each fixed plate are pulled and jacked respectively, so that no combination force applied onto the corresponding fixed plate can be formed to the wedge-caulking push-pull force. At the same time, the push and pull forces can be offset, thus the connection structure of the fixed plates and the carrier main body is more stable and reliable. The above scheme can effectively solve the problems in the prior art.

The technicians in this field can make various forms of the above embodiment under the circumstance that the general spirit and conception of the invention are not deviated. All the forms are in the protection range of the invention. The protection scheme of the invention is subject to the attached claims.

What is claimed is:

1. A display lifting device, wherein the lifting device is used for bearing a display in a suspension mode and comprises:
a left arm plate and a right arm plate fastened on a roof separately;
an upper supporting rod and a lower supporting rod penetrating the left arm plate and the right arm plate in a left-right direction respectively and a display carrier fixedly connected with the display,
wherein the upper supporting rod comprises an upper supporting rod main body and a thread pushing driving part in axial fixed connection with a left end of the upper supporting rod main body through an upper thrust bearing, and the lower supporting rod comprises a lower supporting rod main body and a thread pushing driving part in axial fixed connection with a left end of the lower supporting rod main body through a lower thrust bearing;
wherein external threads are arranged on an external circumference of the thread pushing driving part and the thread pushing driving part in fit with two threaded holes formed in a front of the left arm plate and a back of the left arm plate;
wherein tail ends of the thread pushing driving part and the thread pushing driving part are both provided with a tool junction part for driving rotating;
a top of the display carrier fixedly connected to a left fixed plate and a right fixed plate which are arranged separately in inside sliding grooves of the left arm plate and the right arm plate in a sliding mode;
a positioning protrusion respectively arranged at a top of the inside sliding grooves in the left arm plate and the right arm plate to lock and position the left fixed plate and the right fixed plate when they stretch;
wherein, the positioning protrusions achieve face joint at a position of an end face after installation to improve structure stability;
an end of the left fixed plate and an end of the right fixed plate, which slide into the inside sliding grooves in the left arm plate and the right arm plate and are respectively provided with a contact sensor;
an alarm arranged at the top of the display carrier between the left fixed plate and the right fixed plate;
wherein, the alarm is electrically connected with the contact sensors, so that when the left fixed plate and the right fixed plate slide into the inside sliding grooves in the left arm plate and the right arm plate to enable the contact sensors to be in contact with the positioning protrusions, the contact sensors transfer signals and control the alarm to generate a sound alarm, and the sound alarm generated by the alarm can visually prompt the left fixed plate and the right fixed plate to slide into the inside sliding grooves in the left arm plate and the right arm plate;
an upper taper hole and a lower taper hole, which are separated, are formed in the left fixed plate, and an upper taper hole and a lower taper hole, which are separated, are also formed in the right fixed plate correspondingly;
wherein, the lower supporting rod can penetrate the lower taper hole in the right fixed plate and the lower taper hole in the left fixed plate from the right arm plate and stretch out from the left arm plate, and the upper supporting rod can penetrate the upper taper hole in the left fixed plate and the upper taper hole in the right fixed plate from the left arm plate and stretch out from the right arm plate;
wherein, the upper supporting rod main body comprises an upper supporting rod left conical section matched with the upper taper hole in the left fixed plate, a middle upper supporting rod cylindrical section and an upper supporting rod right conical section matched with the upper taper hole in the right fixed plate; and
wherein, the lower supporting rod main body comprises a lower supporting rod right conical section matched with the lower taper hole in the left fixed plate, a middle lower supporting rod cylindrical section and a lower supporting rod right conical section matched with the lower taper hole in the right fixed plate.

2. The display lifting device firm in connection as claimed in claim 1, wherein a tool junction part is arranged on a peripheral surface or in a inner countersink at the tail end of the thread pushing driving part, and a tool junction part is arranged on the peripheral surface or in the inner countersink at the tail end of the thread pushing driving part.

3. The display lifting device firm in connection as claimed in claim 1, wherein a section of the lower supporting rod main body and/or the upper supporting rod main body is square.
